(19) United States
(12) Patent Application Publication
(10) Pub. No.: US 2004/0016219 A1
(43) Pub. Date: Jan. 29, 2004

(54) Penetrating stalk rolls

(76) Inventor: Marion Calmer, Alpha, IL (US)

Correspondence Address: JAY R. HAMILTON, REGISITERED U.S. PATENT ATTORNEY, PO BOX 1658, BETTENDORF, IA, 52272-0028, US

(21) Appl. No.: 10/623,322

(22) Filed: Jul. 19, 2003

Related U.S. Application Data
(63) Continuation-in-part of application No. 10/376,657, filed on Feb. 28, 2003.
(60) Provisional application No. 60/364,813, filed on Mar. 15, 2002.

(51) Int. Cl. A01D 45/02

(52) U.S. Cl. 56/51; 56/104

(57) ABSTRACT

This patent describes stalk rolls for use in corn head row units. The environmentally friendly stalk rolls improve entry and increase engagement of the fluted portion of the stalk roll with the corn stalk. The stalk rolls described are multi-sectional and contain multi-length variable flutes. The various embodiments of the penetrating stalk rolls may be mounted with or without nose bearings. The number of flutes described for each zone may vary as well as whether the flutes are meshing or non-meshing and angled or non-angled. The stalk rolls described allow a constant speed drive shaft to create lower and/or higher effective circumferential contact speeds within each zone of the stalk roll. The stalk rolls described work to allow smooth uninterrupted improved flow of corn stalk material through the ear separation chamber and are designed to be environmentally friendly by ensuring that the corn plant remains connected to its original root system which prevents it from blowing or washing away. The processing of the corn plant by the improved tapered flutes of the stalk rolls effectively mutilates the corn stalk by the described penetrating, pinching and pulling actions, however, substantially all of the plants are still attached to their root systems and remain relatively intact even though their stalks have been punctured and crimped multiple times. The tapered design of knife edged stalk roll flutes takes advantage of the inherent taper found in corn plant stalks. This novel row unit contains a multi-zone, multi-functional stripper plate that ensures minimal ear wedging and maximum discharge of material other than ears. These stalk rolls may be used with the previously disclosed corn row unit or in combination with the existing corn row units found in the prior art.

### PARENT CASE

This application is a continuation-in-part of U.S. patent application Ser. No. 10/376,657 filed Feb. 28, 2003 entitled “Corn head row unit” which claimed the benefit of provisional patent application U.S. No. 60/364,813 filed Mar. 15, 2002.

### FIELD OF THE INVENTION

This invention relates to corn harvesting machinery, specifically the stalk rolls used in the corn picking row unit of the corn head. The corn head contains several row units. Each row unit contains a row crop divider, a row unit hood, gathering/conveying chain(s), two stripper plates, two stalk rolls, a row unit frame, and a gearbox. The gearbox powers the row unit for gathering corn plants then stripping, separating and conveying ears of corn from the corn plant.

### BACKGROUND OF THE INVENTION

As shown in FIG. 1, corn heads are provided with several row crop dividers for retrieving, lifting, and directing the rows of corn stalks toward their respective ear separation chambers.

FIG. 2 shows the top view of two stalk rolls found in the prior art. These stalk rolls are powered by a gearbox. As the stalk rolls rotate, the flutes on the stalk rolls pull the corn stalks downward. Two stripper plates located above the stalk rolls and on both sides of the corn row are spaced wide enough to allow the corn plant to pass between them but narrow enough to retain the ears of corn which contain grain. This causes the ears of corn to be separated from the corn plant as the corn plant is pulled down through these stripping plates. The stalk rolls continue to rotate ejecting the unwanted portions of the corn plant below the ear separation chamber thereby returning the unwanted portions to the field.

In the past thirty years, four (4) external factors have impacted corn harvesting: (1) Environmentally friendly residue management rules mandate that the farmer keep a certain percentage of crop residue on the surface of the land to prevent soil erosion. (2) Yields have doubled through improved genetics, fertilization, populations, and row spacings. (3) Genetics also improved plant health and stalk vigor. (4) Harvesting machines are larger with increased horsepower, capacity, ground speed and utilize corn heads with more row units.

These factors in combination require that during ear separation modern stalk rolls: (1) Increase the rate of ear separation. (2) Ensure that the corn plant is not severed from its roots system. (3) Increase the speed at which corn stalks are ejected from the row unit. (4) Retain minimal amounts of mote (material other than ears) in the heterogeneous material being delivered to the combine for threshing. (5) Lacerate and or penetrates the shell of the stalk to expose the internal portions of the stalk for accelerated decomposition of the stalk.

The performance of previous stalk rolls, as shown in FIG. 2, has been limited. Attempts at increasing stalk roll performance and increasing ear separation speed have been made by increasing rotational speed of the stalk rolls. This was unsuccessful because stalk roll flutes of the same length rotating at high speeds act like a solid rotating cylinder and do not allow the individual flutes to engage the corn stalk. Thus, corn stalk engagement is hindered and the corn plant stalls without entering the corn stalk ejection area of the stalk rolls. This is also sometimes referred to as an “eggbeater effect”. When the gathering chain paddle passes above the stripper plates and engages this stalled plant, it will break or sever the plant prior to ear separation. Stalk severance prior to ear separation increases intake of material other than ears (MOTE) to the combine thereby increasing horsepower and fuel requirements. This stall may also cause ear separation to take place near the opening of the row unit and allow loose ears to tumble to the ground thereby becoming irretrievable. (See U.S. patent application Ser. No. 10/376,657 filed by applicant.)

FIG. 3 shows a prior art opposing stalk roll design utilizing six flutes which inter-mesh and overlap. When the flutes of this type of stalk roll engage the corn stalk, the flutes alternately apply opposing force. This knife edge relationship causes several problems: (1) The corn plants are violently tossed from side to side causing premature separation of loosely attached ears, thereby permitting the ear to fall to the ground and become irretrievable. (2) The corn stalk is cut or snapped at a node causing long unwanted portions of the stalk and leaves to stay attached to the ear and remain in the row unit. This eventually creates a pile of trash or fluff in front of the cross-auger and feeder house. This problem is compounded as the number of row units per corn head is increased.

FIG. 4 shows the prior art stalk roll design with opposing flutes and intermeshing knife edges as described in U.S. Pat. No. 5,404,699 and issued to Christensen et al. The flutes have knife blade edges and as described are angled with a leading surface at a forward slope of ten (10) degrees. This design upon engagement allows the knife edges to cut stalks off before pulling the stalks through the stripper plates to separate the ear from the stalk, effectively leaving the upper portion of the plant free to float in the corn row unit as shown in FIG. 3. This requires the combine threshing components to process a substantial portion of the stalk; again increasing combine horsepower and fuel requirements.

FIG. 5 shows the design disclosed by U.S. Pat. No. 6,216,428 issued to Becker. This design produces a shearing and cutting of the stalk using a scissor configuration produced by the leading and trailing edges of the opposing knife edged flutes. Again the corn stalks are cut-off prior to ear separation. This is sometimes referred to as a scissor effect and also results in the need to process increased amounts of MOTE.

The stated objective of the prior art disclosed in FIGS. 4 and 5 is to promote faster decomposition of the crop residue, increased erosion control and decreased plugging of tillage tools. However, a finely cut stalk that is severed from the ground may actually reduce the erosion protection provided by crop residue because it washes or blows from the field leaving the soil particles susceptible to erosion due to rain or wind. This type of crop residue management system has now been determined to be environmentally unfriendly.

### SUMMARY OF THE INVENTION

The present invention contains an ear separation chamber which is the area between the row unit covers and above the stripper plates and extends through all the zones. It designates at least four (4) interrelated overlapping zones with separate functions and purposes within each row unit. The combination of zones, relationships and sub-functions improves the performance of the corn head and combine by allowing better material flow through the row unit, reducing congestion mote levels through the row unit, conveying systems and the combine, thereby improving combine speeds and efficiencies. The four (4) current interrelated overlapping zones are the Alignment, Entry, Ear Separation and Post-Ear Separation Plant Ejection Zones.

This invention also provides for variable circumferential speeds. There are at least three critical circumferential speed ratios related to ground speed for optimum high efficiency harvesting. This invention provides that the three circumferential speed ratios are interrelated and effective row unit designs must recognize and incorporate these varied speed ratios to ensure corn plant(s) remain vertical or lean slightly toward the corn head upon engagement. Harvesting corn plants in this manner promotes ear separation in the targeted Ear Separation Zone and away from the front of the row unit. Targeting ear separation in this zone, and manner, reduces losses from ears tumbling out of the corn head row unit and onto the ground thereby becoming irretrievable.

The three critical speed ratios are: 1) Combine ground speed to row unit horizontal gathering/conveying chain speed. The gathering/conveying speed must be the same as or faster than the ground speed. 2) Combine ground speed to stalk roll transport vane horizontal speed. 3) Combine ground speed to row unit vertical ear separation speed. The vertical ear separation speed (sometimes referred to as vertical stalk speed) must be the same as or faster than the ground speed. However, the maximum vertical stalk speed before ear separation is the highest speed at which the ears of corn are not damaged upon impact within the row unit. Damage to the corn ears is sometimes referred to as “butt-shelling”. Each of these critical speed ratios constrains the operating speed of each zone described herein. Operating outside the critical speed ratio constraints within each zone produces sub-optimal performance. Obeying all the critical speed ratios, as required by high speed, high yield and or down corn harvesting operations, requires the effective circumferential speed and interaction of the multi-length, multi-angled, multi-vaned stalk rolls described in each in zone to vary while accomplishing the functions described in each zone.

The Alignment Zone

The purposes of this zone are to align, direct and gather the corn plant for conveyance to the Reception Zone with the corn ear intact and positioned for recovery with minimal mote. The entire zone is shown in view B-B of FIGS. 10-12 and FIG. 6A.

FIG. 6A shows the improved row unit with three improvements to the gathering/conveying chain paddles (or lugs): 1) The number of gathering chain paddles is reduced providing a larger conveying chamber thereby reducing ear slippage and improving engagement between the ears and paddles. This allows more detached ears to fall into the enlarged conveying chamber. Thereby, increasing the conveying efficiency of the chain and decreasing the number of non-engaged ears in the separation chamber during the ear separation process. 2) The size of the gathering chain paddles is increased. Taller paddles reduce ear slippage and retain more ears. Additionally, in down corn, ear separation does not always occur at the targeted location causing loose airborne ears to be tossed wildly about the ear separation chamber. 3) The approach angle of the paddles is increased. Increasing the angle of the taller paddles increases the gathering aggressiveness of the chains when retrieving down corn stalks from near ground level into the row unit. This combination of improvements creates an enlarged and more aggressive conveying chamber for improving the gathering/conveying chains retrieval capacity and efficiency. FIG. 6 illustrates the invention's improvement of the stripper plate configuration as disclosed as in U.S. patent application Ser. No. 10/376,657. In the Alignment Zone, the stripper plate has flat surfaces to reduce the tendency of the ears that are being retrieved from near ground level to wedge or torpedo below the stripper plates.

The Entry Zon

The primary purpose of this zone is to allow entry of the corn plant into the stalk rolls. This zone is shown in view C-C of FIGS. 10-12. The rate at which corn stalks are accepted into the row unit controls harvesting speed. The prior art teaches that to increase the rate of entry, the rotating speed of the stalk roll must be increased. However, increasing the rotational speed of the stalk roll creates an “egg-beater” effect. This stalk roll will not engage the corn stalk because the relative area of the opening by which the contact surfaces of the flutes may contact, pinch or grab the stalk of the corn plant is insufficient. If the stalk of the corn plant is not pinched, the stalk stalls in the row unit. Increasing rotational speed within this section of the row unit amplifies this weakness of the prior art. Stalk stall allows the rotating flute edges to sever the corn plant. This stall also causes the corn plant to lean away from the row unit and ear separation to take place near the opening of the row unit that allows loose ears to tumble to the ground thereby becoming irretrievable.

The present invention further improves upon the invention disclosed in patent application 10/376,657 by reducing the effective circumferential speed of the stalk rolls to allow entry and engagement. Improved entry and engagement are accomplished by first contacting the corn plant stalk with rotating transport vanes located on the helical nose cone at the entry area to the stalk roll flutes. The rotating transport vanes may be either timed or non-meshing, so as to provide positive material flow in tough, damp, or high speed harvesting conditions as indicated in FIG. 12, view B-B. The rotating transport vanes also center the corn plant in the ear separation chamber. Next, the invention incorporates a revolving window or windows, comprising multi-length flutes with shorter opposing flutes, within the Entry Zone, as shown in FIG. 12, view C-C. The revolving window within the stalk roll opens to allow entry of the stalk. A revolving window or a plurality of windows is envisioned. The inventor herein describes the preferred embodiment to have two revolving windows per one complete revolution of the stalk rolls. The rotating transport vanes lock the stalk into the revolving window. The perimeter of the stalk is then pinched by the longer flute for increased engagement between the multi-length, multi-fluted, stalk roll and the corn stalk as shown in FIG. 12E-E and FIG. 17. Increased engagement thereby increases the effectiveness of the zones within the ear separation chamber promoting the occurrence of rapid and clean ear separation within the Ear Separation Zone. The present invention provides that the stalk rolls can be mounted either in a cantilevered or non-cantilevered manner.

A further improvement described herein and not previously described or claimed provides for an improvement in the above described Entry Zone. This improvement compromises tapering the stalk rolls to modify the configuration of the Entry Zone to further improve performance of the Entry Zone. The tapered stalk roll takes advantage of the natural attribute present in standing corn—the diameter of the corn stalk at its base i.e. ground level is larger than its diameter towards its tip or tassel. The largest gap between the tapered stalk rolls is at the entry to the stalk rolls; the smallest gap at the point of exit of the stalk rolls. This taper in the stalk rolls balances the outward forces created by the plant against the stalk roll flutes and the inward force of the flute against the stalk. An imbalance of the forces can create a pulsation in the stalk rolls during operation. This pulsation creates a moment about the gearbox which can produce premature failure in the gearbox or its supporting mechanisms. Tapering the stalk rolls reduces the potential for pulsation while promoting entry of the corn stalks into the rolls and allowing aggressive engagement between the stalk rolls and the corn plant stalk.

The Ear Separation Zone

The primary purpose of this zone is to separate the ear from the plant and retain it. The objective of the stalk rolls in this zone is to pull the stalk through the stripper plates while maintaining the integrity of the stalk. The maximum vertical stalk speed allowed is such that minimal damage to the ear occurs. Views D-D of FIGS. 10-12 best illustrate this zone. As best shown in FIGS. 12D-D and 17, this invention provides that the non-meshing flutes of the stalk roll be timed and opposite with minimal clearance so that as one flute edge begins to pull the corn stalk down the opposing flute edge pulls the corn stalk down at a point on the horizontally opposite side thereof. This balanced pinching action reduces lateral corn plant whipping. When the corn plant is whipped, the stalk can dislodge and toss the ear from the stalk or prematurely break or sever. The balanced pinching action allows the stalk roll to evenly pull the stalk down so that the stripper plate may rapidly separate the ear from the stalk in the Ear Separation Zone.

As shown in FIG. 10, view D-D of FIG. 12 and FIG. 17, in this zone the present invention uses a stripper plate that has a rounded or contoured surface to emulate the arched under side of the corn leaf with two positive effects. The emulation of the shape allows the corn leaf to stay attached to the corn stalk reducing the level of mote retained in the chamber. This shape also improves separation of the husk from the ear of corn further reducing the level of mote in the chamber. As indicated in FIG. 17, this invention also provides that the stalk roll flutes and stripper plates be closely adjacent to reduce the amount of mote retained in the ear separation chamber in the event that stalk separation takes place before ear separation. Stalk separation occurs when the stalk separates from itself. This occurs when the strength of the connection point of the ear shank is stronger than the stalk itself.

The Post-Ear Separation Plant Ejection Zone

View E-E of FIGS. 10-12 shows the configurations of the Post-Ear Separation Plant Ejection Zone. The primary purpose of this zone is to rapidly eject the stalk from the row unit to minimize interference between mote and ears of corn. No specific speed ratio controls the operating speed of this zone. After ear separation, increasing stalk ejection speed effectively reduces mote entering the threshing (kernel separation) area of the combine thereby increasing threshing efficiency and capacity. As disclosed and claimed in U.S. patent application Ser. No. 10/376,657, the primary changes incorporated by the invention in this zone are the increase in circumferential speed of the stalk rolls and the low row profile unit covers. This invention also provides that within this zone, the stalk roll flutes can be both meshing and non-meshing so as to create a high speed clean out zone. The stalk rolls may also be aerodynamically designed to create a suction effect of unattached airborne mote from the ear separation chamber thereby returning this material to the field.

Low profile row unit covers are found in the Post Ear Separation Zone but improve performance in all the zones. FIGS. 7, 8 and 9 highlight the low profile row unit cover and the necessary improved mounting hardware. Low profile row unit covers offer an improvement in all situations but are most beneficial in the harvesting of lodged, tangled or down corn. The low profile row unit cover reduces the angle of the inclined plane the mass of unattached tangled corn plants must overcome as they are moved from the row unit. The low profile row unit cover also minimizes the distance between the mass of unattached tangled corn plants and the gathering/conveying chain paddles. Engagement between the paddles and the corn plants for further powered movement is increased when the above distance is minimized.

While the practical advantages and features of the present invention and method have been briefly described above, a greater understanding of the novel and unique features of the invention may be obtained by referring to the drawings and detailed description of the preferred embodiment which follow.

LISTING OF THE ELEMENTS

| Number | D scription |
|---|---|
| 100 | row dividers |
| 110 | gathering chain paddles (enlarged) |
| 120 | gathering chains |
| 130 | stripper plates |
| 140 | ear separation chamber |
| 150 | row unit cover |
| 151 | row unit mounting brackets |
| 155 | row unit cover (largest plane) |
| 170 | rotating transport vanes |
| 175 | revolving entry window |
| 180 | stalk roll flutes non-meshing configuration |
| 181 | stalk roll flutes intermeshing configuration |
| 182 | stalk roll flutes non-meshing in the ear separation zone |
| 183 | taller stalk roll flutes in the post-ear separation zone |
| 190 | stalk rolls (non-meshing configuration) |
| 192 | stalk rolls (intermeshing configuration) |
| 200 | cross auger trough |
| 220 | cross auger |
| 230 | cross auger flighting |
| 300 | corn plant ear |
| 310 | arched portion or underside of the corn plant leaf |
| 320 | corn stalk |
| 321 | outer shell of corn stalk |
| 330 | corn stalk node |

### DESCRIPTION OF THE DRAWINGS

FIG. 1—is a top view of a corn head which contains a cross auger, a feeder house, a frame, and multiple row units of the prior art.

FIG. 1A—is an exploded view of a portion of one row unit of FIG. 1 of the prior art.

FIG. 2—is sectional view A-A of one row unit, the cross auger, the trough, the feeder house, and its conveyor chain of FIG. 1 as disclosed in the prior art.

FIG. 3—is sectional view F-F of FIG. 1 of highlighting only the stalk rolls and stripper plates of one row unit of the prior art engaged with a corn plant.

FIG. 4—is an end view of a cutting type stalk rolls as disclosed in the prior art.

FIG. 5—is an end view of a shearing type stalk rolls as disclosed in the prior art.

FIG. 6—is a top view of a corn head incorporating row units of this invention and as disclosed in pending patent application Ser. No. 10/376,657.

FIG. 6A—is an exploded view of a portion of one row unit of FIG. 6 of this invention and as disclosed in pending patent application Ser. No. 10/376,657.

FIG. 7—is sectional view G-G of FIG. 6 showing only the improved row unit cover(s) and necessary mounting hardware disclosed and claimed in pending patent application Ser. No. 10/376,657.

FIG. 8—is an end view of FIG. 6 incorporating the invention and components of pending patent application Ser. No. 09/827563 and end row unit cover, improved end wing divider, and telescoping tube divider as previously claimed and disclosed in pending patent application No. 10,376,657.

FIG. 9—is sectional view A-A of FIG. 6 incorporating this invention and components of pending patent application Ser. No. 09/827563 Strategic Spatial Realignment for Attaching corn heads to combines.

FIG. 10—is a top view of the ear stripping plates of the present invention with sectional lines and as disclosed in pending patent application Ser. No. 10,376,657.

FIG. 11—is a top view of the stalk rolls of the present invention with sectional lines and as disclosed in pending patent application Ser. No. 10,376,657.

FIG. 12—is sectional views B-B, C-C, D-D, and E-E of FIGS. 10 & 11.

FIG. 13—is a top view of the tapered penetrating stalk rolls as used in a flute-to-flute configuration.

FIG. 13A-A is a view at the entrance to the tapered penetrating stalk rolls as used in a flute-to-flute configuration as shown in FIG. 13.

FIG. 13B-B is a view of the tapered portion of the penetrating stalk rolls as used in a flute-to-flute configuration as shown in FIG. 13.

FIG. 13C-C is a view at the end of the stalk rolls as used in the Post Ear Separation zone as disclosed in pending patent application Ser. No. 10/376,657.

FIG. 14—is a top view of the penetrating stalk rolls in a flute-to-flute configuration and with the stalk rolls tapered in an angular inverted stair-step like manner.

FIG. 14A-A is a view at the entrance to the tapered penetrating stalk rolls in a flute-to-flute configuration and with the stalk roll tapered in stair-step like manner as shown in FIG. 14.

FIG. 14B-B is a view of the tapered portion of the penetrating stalk rolls in a flute-to-flute configuration and with the stalk roll tapered in a stair-step like manner as shown in FIG. 14.

FIG. 14C-C is a view at the end of the stalk rolls as used in the Post Ear Separation zone as disclosed in pending patent application Ser. No. 10/376,657.

FIG. 15—is a top view of the penetrating stalk rolls in a flute-to-flute configuration and with the stalk rolls tapered in an angular inverted stair-step like manner.

FIG. 15A-A is a view at the entrance to the tapered penetrating stalk rolls in a flute-to-flute configuration and with the stalk roll tapered in an angular inverted stair-step like manner as shown in FIG. 15.

FIG. 15B-B is a view of the tapered portion of the penetrating stalk rolls as in a flute-to-flute configuration and with the stalk roll tapered in angular stair-step like manner as shown in

FIG. 15.

FIG. 15C-C is a view at the end of the stalk rolls as used in the Post Ear Separation zone as disclosed in pending patent application Ser. No. 10/376,657.

FIG. 16—is a top view of the tapered penetrating stalk rolls as disclosed in an intermeshing configuration.

FIG. 16A-A is a view at the entrance to the tapered intermeshing penetrating stalk rolls as disclosed in FIG. 16.

FIG. 16B-B is a view of the tapered portioned of the penetrating stalk rolls as used in an intermeshing configuration as shown in FIG. 16.

FIG. 17—is sectional view D-D of FIG. 12 with a corn plant engaged with the stalk rolls and stripper plates of present invention and as disclosed in pending patent application Ser. No. 10,376,657.

FIG. 17A—is an exploded view of the corn stalk post-penetration and laceration of the corn stalk.

FIG. 18A—is an exploded side view of the tapered penetrating stalk rolls showing the angle of the flute edges prior to engagement with a corn stalk.

FIG. 18B—is an exploded side view of the tapered penetrating stalk rolls showing the angle of the flute edges as a corn stalk would be engaged.

FIG. 18C—is an exploded side view of the tapered penetrating stalk rolls showing the angle of the flute edges after the corn stalk has been engaged.

### DETAILED DESCRIPTION OF THE INVENTION

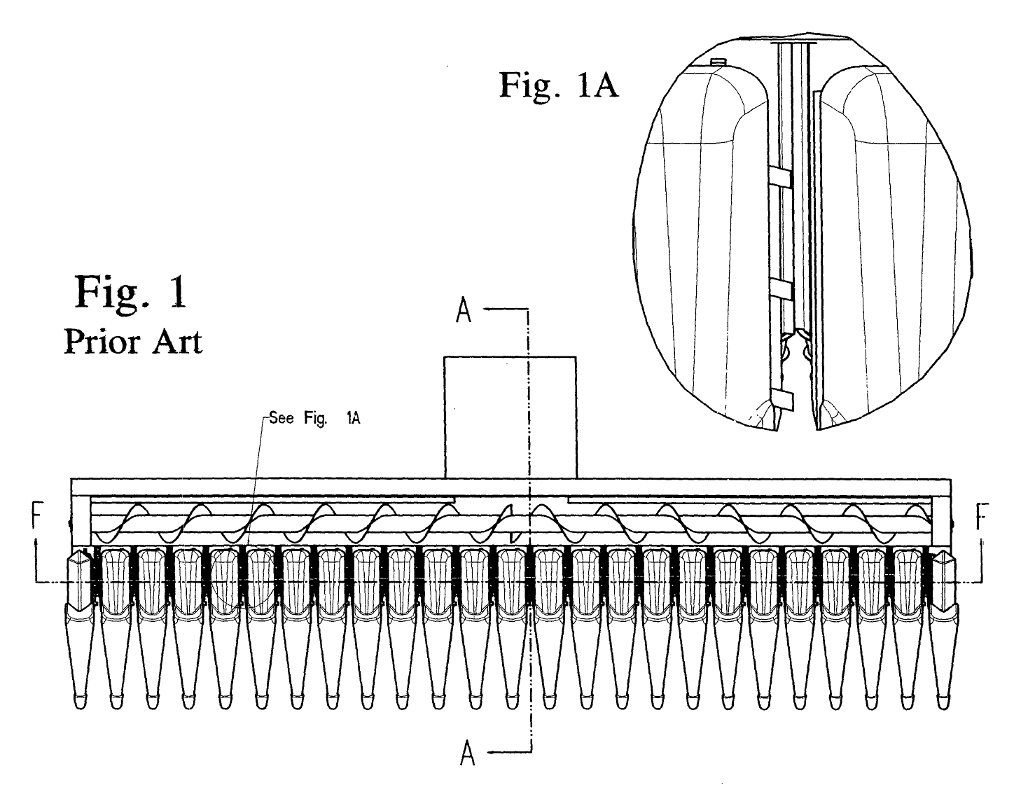

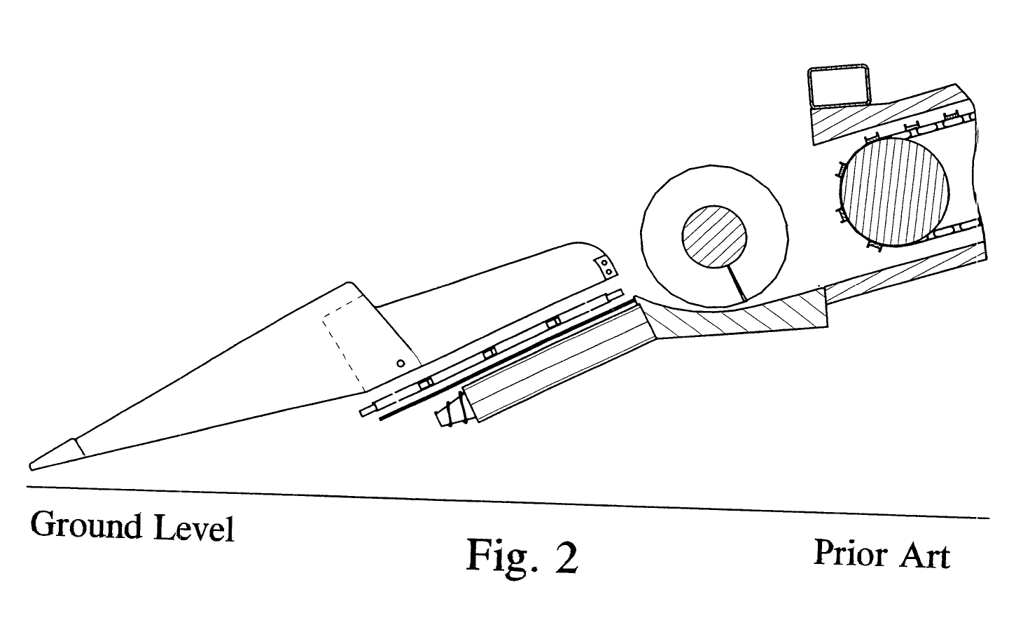

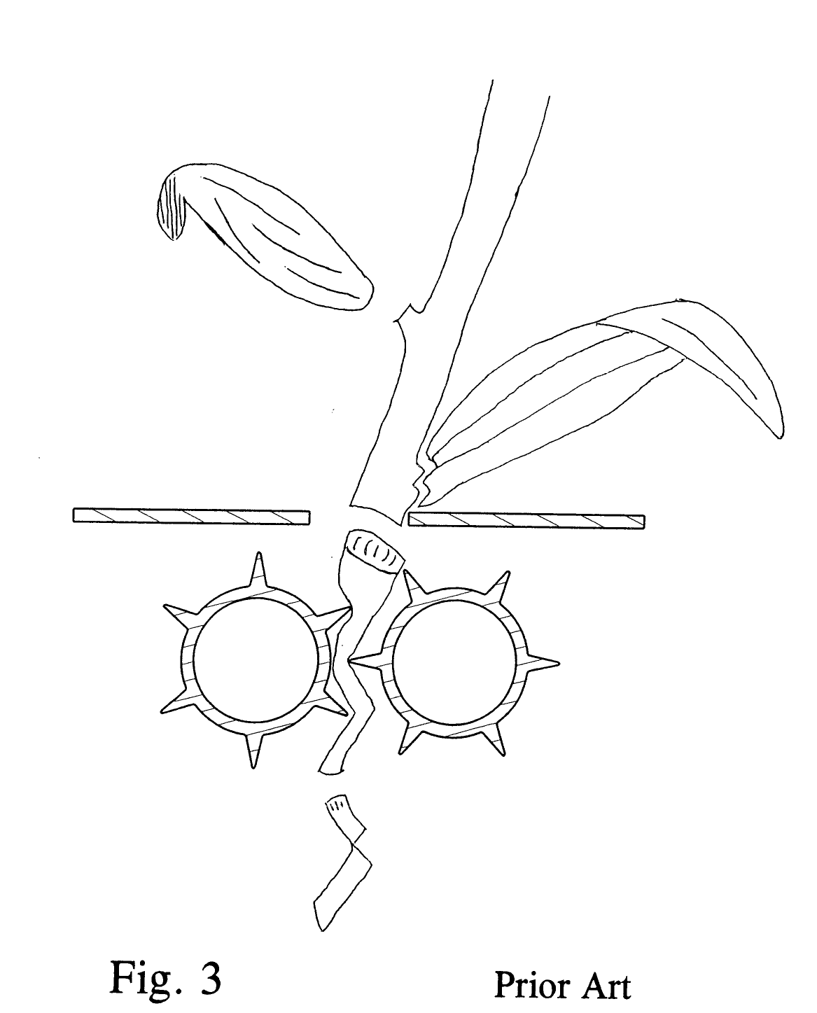

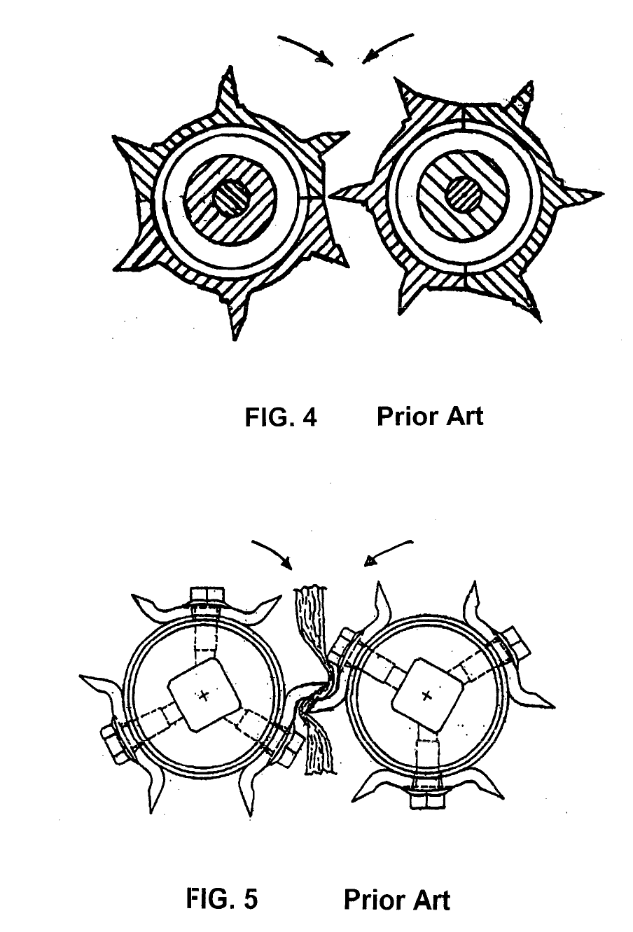

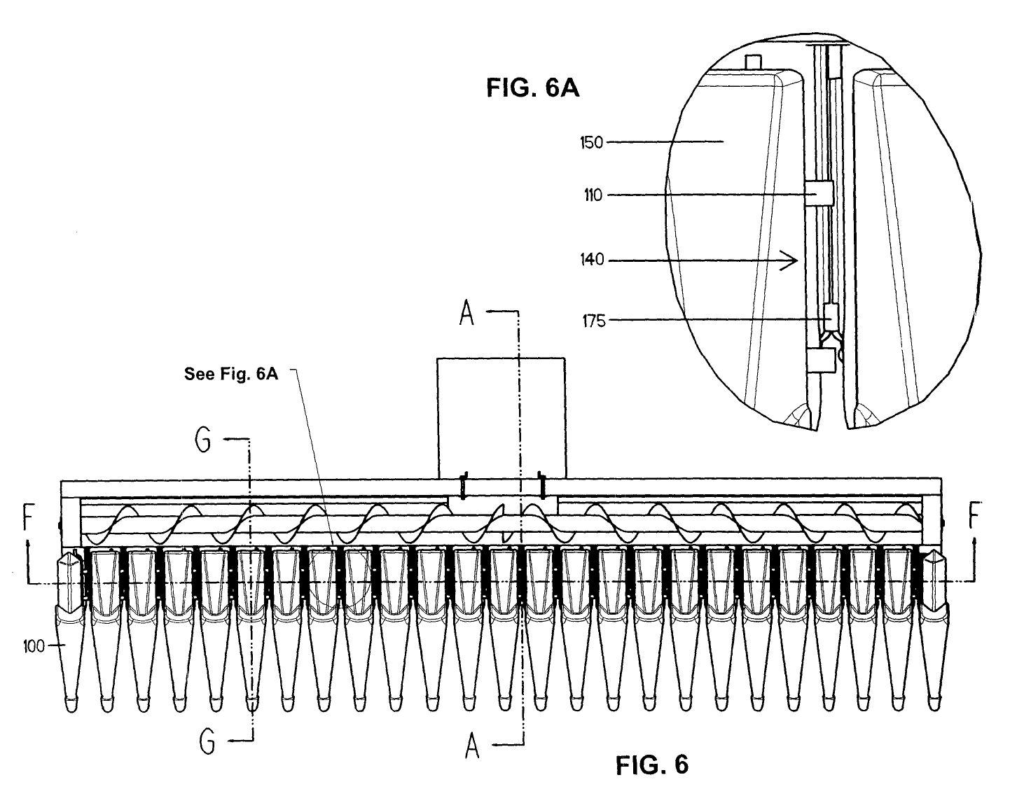

The general operation of corn heads incorporating this invention in FIGS. 6 thru 18 are similar to that of the operation of corn heads of the prior art as illustrated in FIGS. 1-5. The power to drive this corn head row unit is provided from a main drive shaft through a gearbox as described in the prior art.

In FIGS. 6-9 the corn stalks are lifted and guided toward the row unit by dividers 100. In FIGS. 6A, 8 and 9 rotating gathering chain 120 contains enlarged gathering paddles 110 and directs the corn plants toward the ear separation chamber 140. In FIGS. 6A & 8 the corn plants are further centered into the ear separation chamber 140 by improved stripper plates 130. In FIG. 6A enlarged gathering chain paddles 110 have an increased angle relative to the gathering chain 120 which makes them more aggressive when gathering down corn plants.

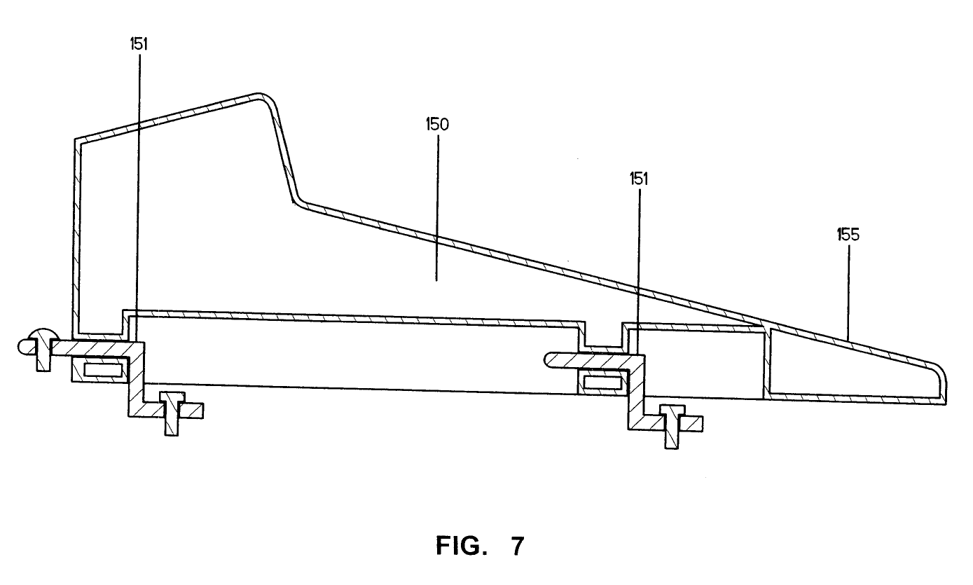

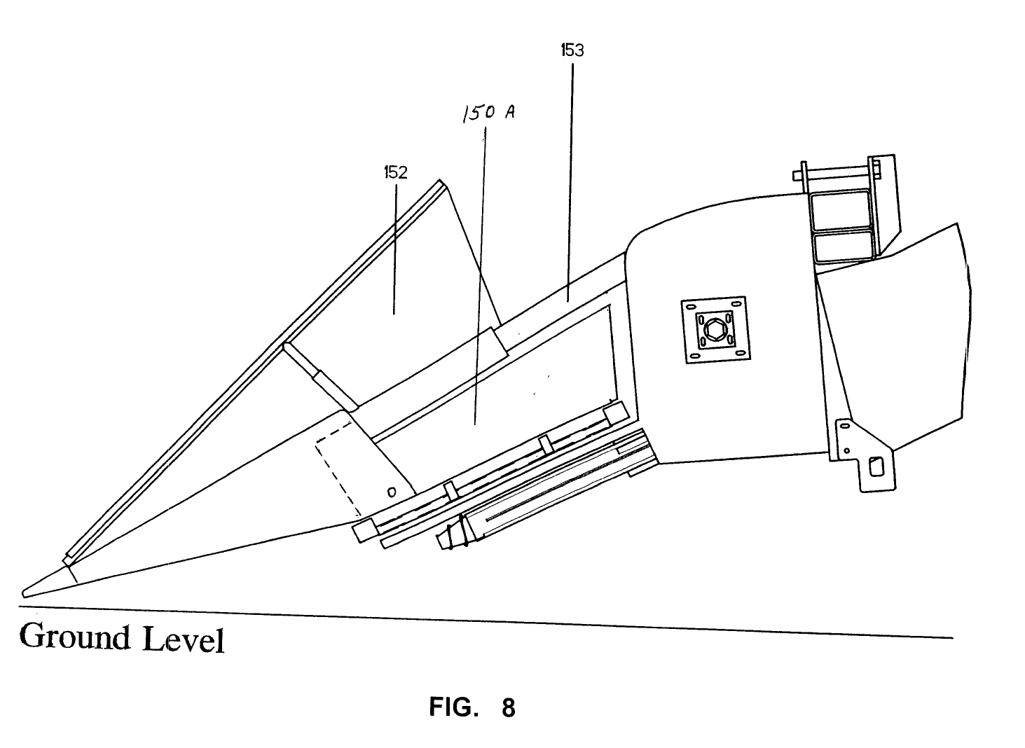

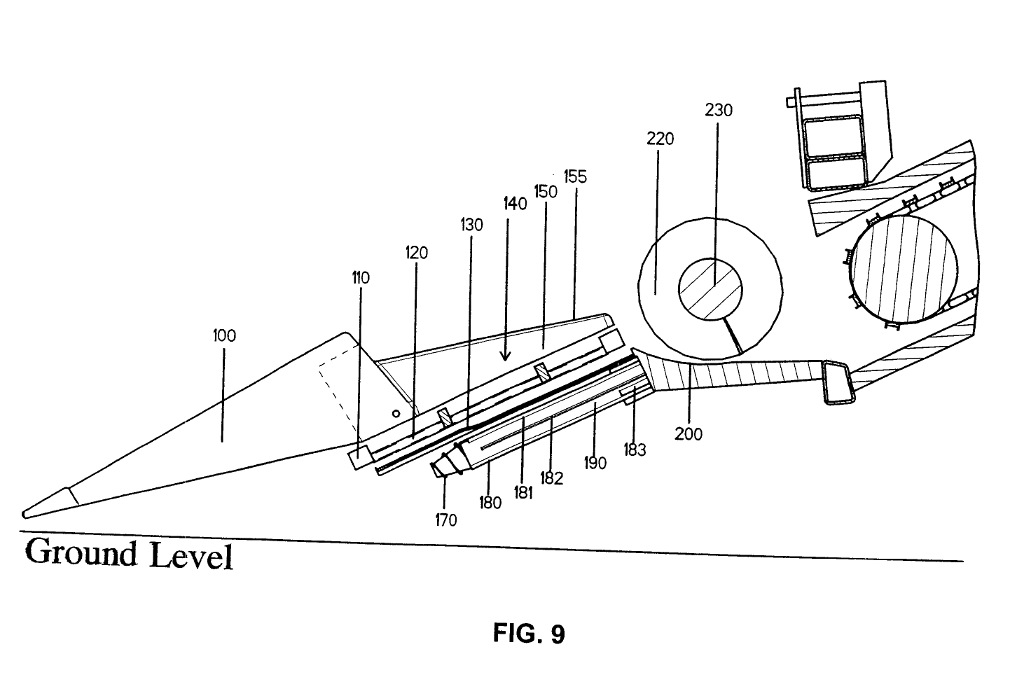

In FIG. 7 when harvesting down corn some corn plants are severed or broken as the row dividers 100 and row unit cover 150 lift and separate tangled plants. In FIG. 7 the improved low profile row unit cover 150 has minimal rear height. The single largest plane that is contacted by crop material is shown by 155 in FIGS. 7 and 9. This height reduction is made possible by the unique mounting brackets 151 in FIG. 7. This reduction in height has two benefits: (1) It lessens the angle of inclined plane for which any dislodged material must overcome as it travels to the cross auger flighting 230 for conveyance. (2) It keeps this mass of material close to gathering chain paddles 110 for improved engagement.

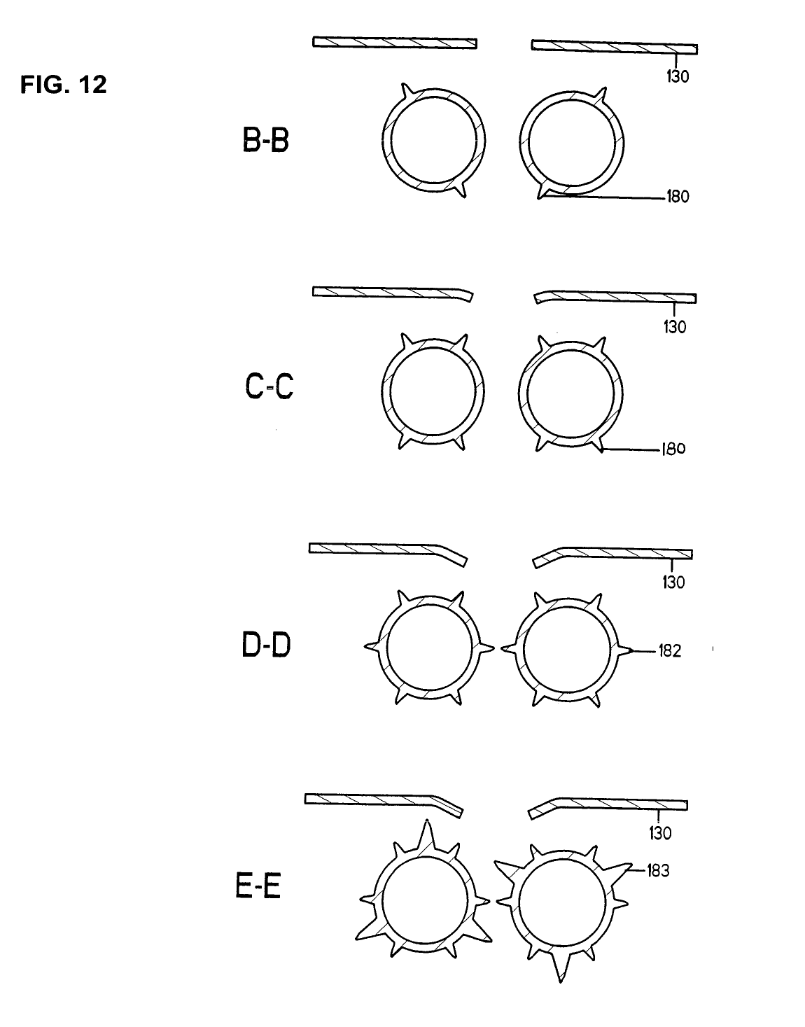

In FIG. 9 the corn plants are gathered and further propelled rearwardly by means of the force imparted by rotating transport vanes 170, which are oppositely wound and strategically timed to be horizontally opposite. The transport vanes 170 positively direct and lock the corn stalk 320 into the entry of the stalk rolls 190 with revolving entry window 175. Alternatively, the revolving entry window 175 may be replaced with stalk rolls with tapered flutes as shown in FIGS. 12-16. The strategic lateral speed imparted to the corn stalk 320 by rotating transport vanes 170 is determined by the angle of the vanes. This lateral speed is equal to or faster than the lateral speed imparted to the corn stalk 320 by gathering chain paddles 110.

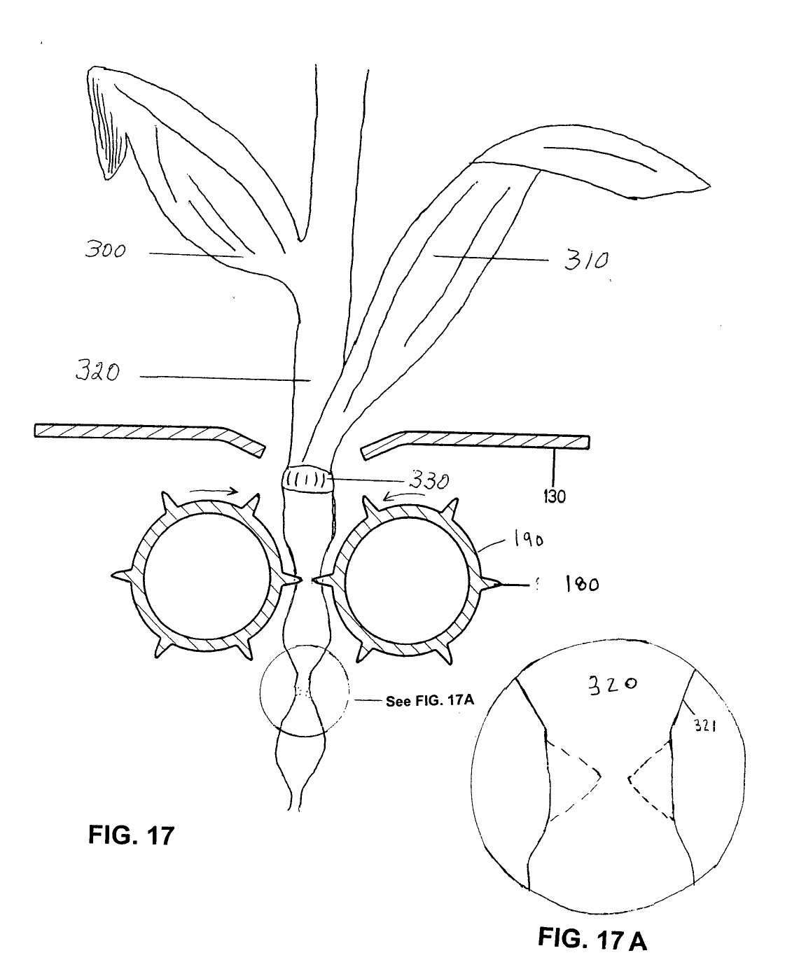

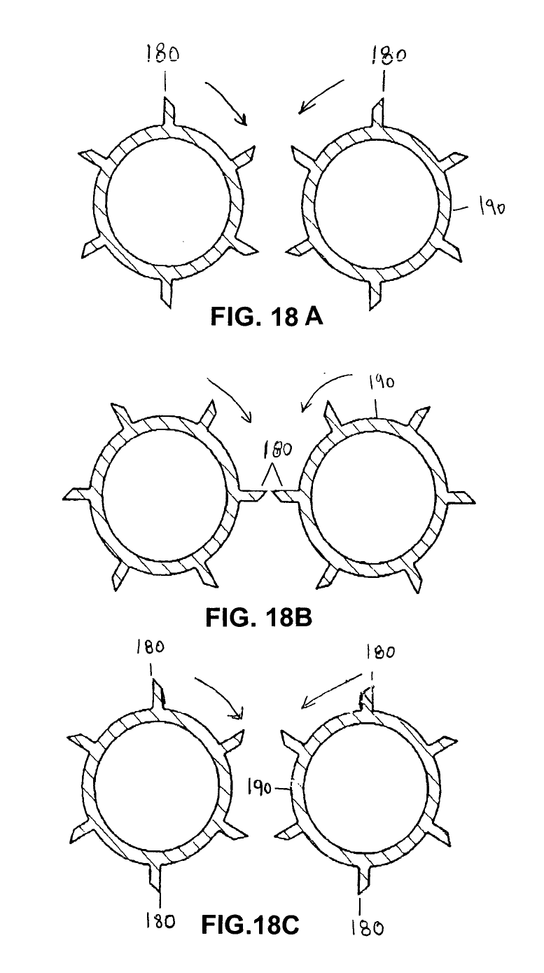

As shown in FIGS. 7-10 stalk roll flutes of different lengths in a stair-stepped assembly create a revolving entry window or windows 175. This revolving entry window(s) 175 allows that as stalk rolls 190 rotate the next set of flutes 180 which extend further engage with the perimeter of the corn stalk 320 for initial pinching and downward pulling of the corn plant as described by FIG. 17 and 18. The remaining sets of flutes further engage the corn stalk 320.

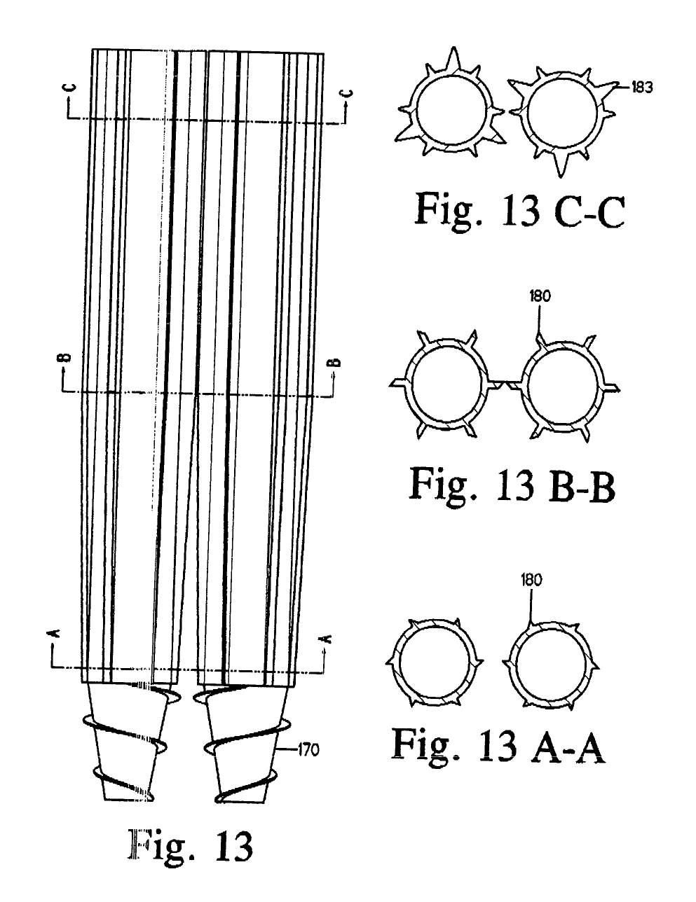

FIG. 13 shows the preferred embodiment of the invention. In this embodiment, the opposing flutes 180 of the stalk rolls 190 are timed so that they meet during operation. They do not, however, ever touch during normal operation. The distance between the stalk rolls decreases from point A-A to point B-B as shown by FIGS. 13A-A and 13B-B, respectively. This configuration provides optimum balanced pressure against the corn stalk 320 to first pinch it and then pull it down while penetrating the outer shell of the corn stalk 321, thus avoiding stalk whip, during engagement of the corn stalk 320. See FIG. 17A.

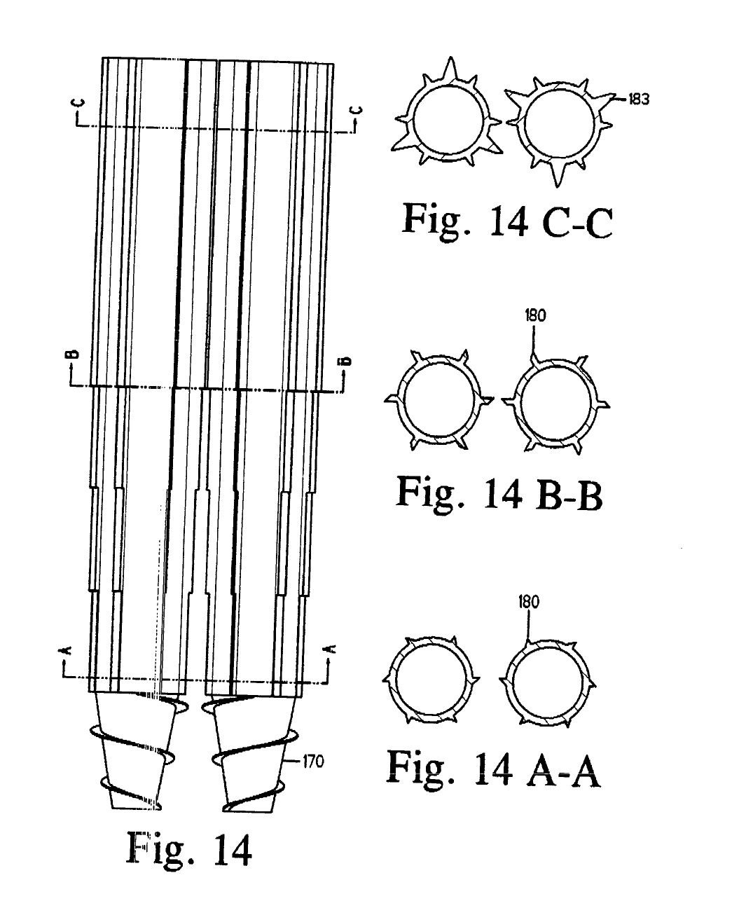

FIG. 14 illustrates another embodiment of the present invention. In this embodiment, the distance between the non-meshing opposing stalk roll flutes 180 is reduced in discrete increments from point A-A to point B-B along the length of the stalk roll as shown by FIGS. 13A-A and 13B-B, respectively. This embodiment could also be operated with the stalk roll flutes 180 in a meshing configuration.

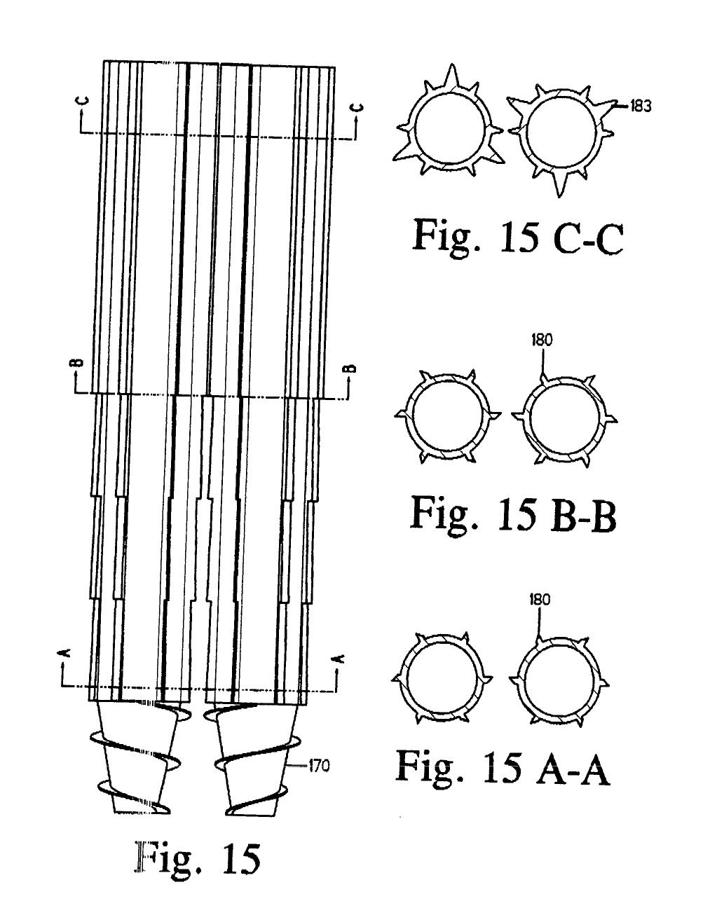

FIG. 15 illustrates another embodiment of the present invention. In this embodiment, the distance between the non-meshing stalk roll flutes 180 is reduced discretely as in FIG. 14. Additionally, in this embodiment, however, there is a further taper in the flute edges between the discrete points where the distance between the flute edges has been reduced resulting in a combined stair-step with a taper type shape.

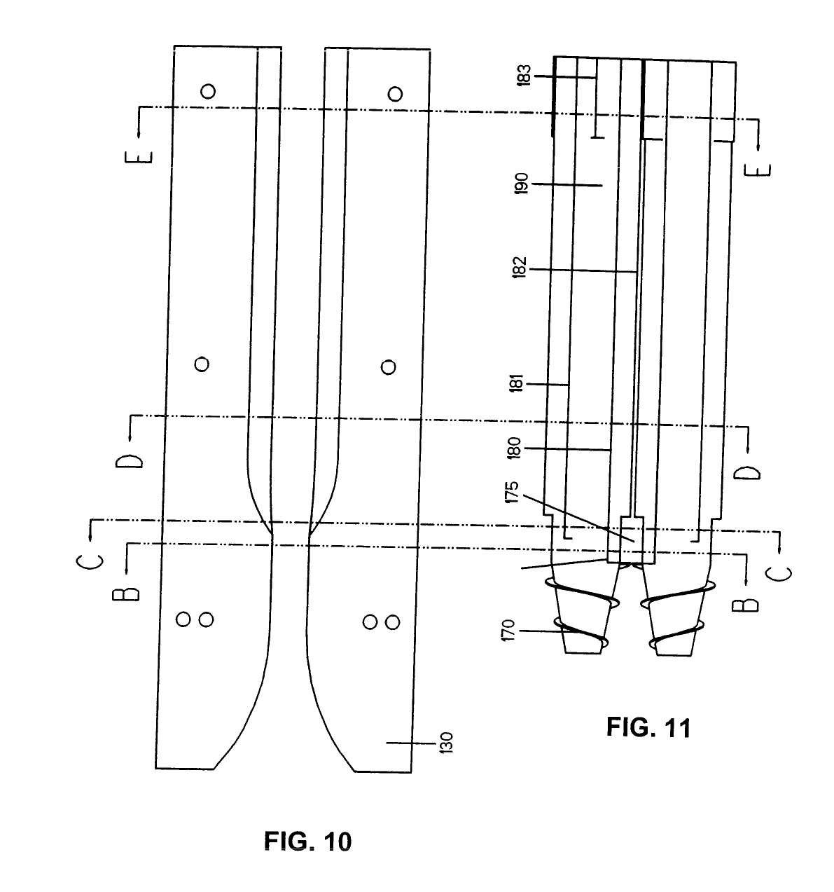

In FIG. 10 and view B-B of FIG. 12 the stripper plates 130 are flat in the Alignment and Entry Zones reducing ear wedging below stripper plates 130, and above the rotating transport vanes 170 of non-meshing stalk rolls 190 when ears are being gathered from near ground level.

In FIGS. 8, 9, 11, 12 D-D, the Ear Separation Zone of the stripper plates 130 is normally directly above the fluted portion of stalk rolls 190 and is slightly curved down. In FIG. 17 this curve emulates the arched portion or underside of the leaf 310. This improved curved shape allows smooth flow of unwanted portions of the corn plants to pass between stripper plates 130 and exit the ear separation chamber 140 while retaining the ear 300.

As shown in FIGS. 6, 8, 9, & 13-16 rotating non-meshing and intermeshing stalk rolls (190 and 192, respectively) are mounted in the preferred cantilevered manner for rotation by their respective stalk roll drive shaft, thereby eliminating support brackets or bearings.

In FIGS. 12-15 the plurality of flutes 180 of stalk rolls 190 are timed to be non-meshing and horizontally opposite of each other thereby causing the flute edges to pinch the stalk 320 simultaneously as they rotate, thus providing that the resultant equal forces are applied to both sides of the engaged stalk 320 so as to eliminate corn plant whip. This keeps the stalk 320 perpendicular and reduces any whipping action that prematurely dislodges the ear 300 from the corn stalk 320 or snaps the stalk at the node 330. The remaining flutes of stalk roll 190 then further pinch the corn stalk 320 pulling it down and rearwardly so that the ears of corn 300 are removed from the stalks 320 as they come into contact with the desired ear separation zone of stripper plates 130. As shown in FIG. 17, the epidermis i.e. outer shell of the corn stalk 321 is punctured and the inner portion of corn stalk 320 is not normally broken or severed which allows corn stalk 320 to stay attached to its original root system. See T. A. Kiesselbach, “The Structure and Reproduction of Corn”, pages 25-29, 1980. This is viewed in today's agriculture as being more environmentally friendly.

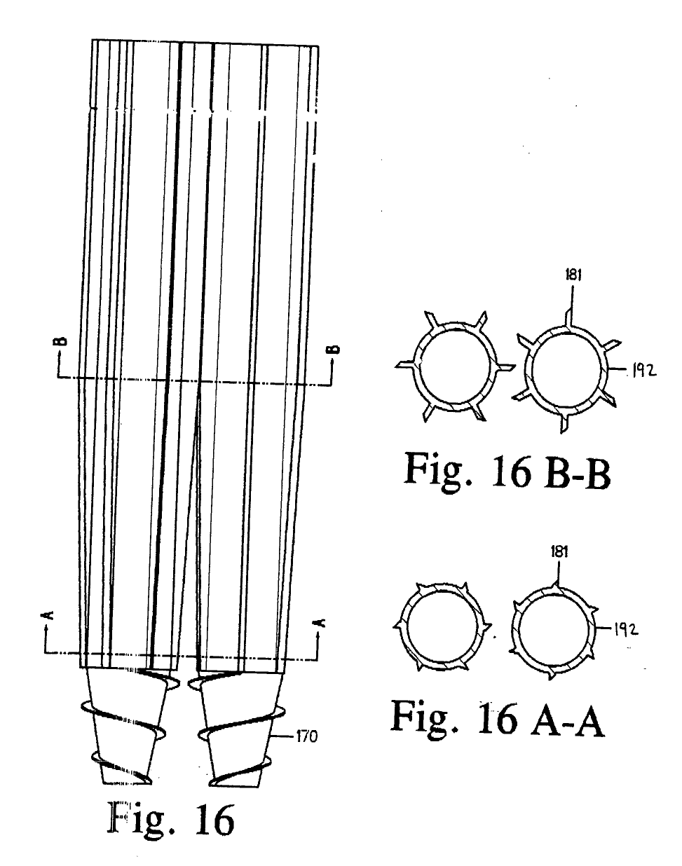

FIG. 16 shows a set of stalk rolls in the intermeshing configuration 192 with tapered flutes 181. During operation, as a corn plant is pulled down and through the corn row unit, the distance between the intermeshing tapered flutes 181 and the opposing stalk roll 192 is reduced thereby increasing penetration of the corn stalk and exerting continuous pressure against the corn stalk 320 as it is pulled down into the row unit.

In view E-E of FIG. 12, a clean out zone is created by adding short lengths of tall meshing flutes 183 between non-meshing flutes 180. Using inter-meshing flutes 183 allows faster ejection of small diameter corn stalks, normally found in this portion of the zone from the upper most portion of the corn plant. The intermeshing flutes 183 of stalk rolls 190 or 192 are aerodynamically designed and assembled to create a down draft through the ear separation chamber 140, which further enhances removal of any mote. The preferred embodiment is a non-meshing stalk roll configuration 190 with a cleanout zone employing both intermeshing flutes 183 and non-meshing flutes 180. FIGS. 13C-C, 14C-C and 15C-C show penetrating stalk rolls combined with a clean-out zone. The penetrating stalk rolls as disclosed herein are also operable without the clean-out zone shown in the figures.

In FIG. 6A and 8 the reduced number of enlarged gathering chain paddles 110 increases the conveying capacity of the ear separation chamber 140 to carry separated ears rearward. This improved capacity increases the conveying efficiency of the gathering chain paddles 110 to the cross auger trough 200 which contains auger 220 and flighting 230 for conveyance to the feeder house area.

FIG. 17 shows how the tapered flute-to-flute design disclosed by the present invention is envisioned to work by the inventor during operation. As the stalk rolls 190 rotate, the sharpened edge of the non-meshing stalk roll flutes 180 penetrate the outer shell of the corn stalk 321. The penetration of the stalk roll flute 180 combined with the rotation of the stalk rolls 190 results in both a pulling and lacerating action to the corn stalk 320. Because the entire row unit is moving forward during operation, the tapered stalk roll flutes 180 penetrate deeper and deeper into the corn stalk 320 as it is pulled down into the row unit. The difference in height between the stalk roll flutes 180 and the stalk roll barrel 190 results in a continuous compressing-decompressing action against the corn stalk. This action crimps the corn stalk 320. See FIG. 17A herein.

FIGS. 18A-C illustrates the non-meshing tapered stalk rolls as they rotate 180 degrees during operation. In FIG. 18A, the non-meshing tapered stalk roll flute 180 is marked at the top of the rotation prior to contact with the corn stalk 320. As the stalk roll rotates, the edge of the flutes 180 will engage and begin to pinch the corn stalk. In FIG. 18B, the non-meshing tapered stalk roll flute 180 has been rotated 90 degrees. The opposing flutes 180 are directly opposite each other. The pressure exerted by stalk roll flute 180 on the corn stalk has lead to penetration of the corn stalk 320. The rotation of the stalk roll 190 has pulled the corn stalk down into the corn row unit. Penetration by the flute 180 is at maximum depth in FIG. 18B. Opposing flutes 180 do not touch each other during the cycle to avoid cutting through the corn stalk 320. The angle of the knife edges have a predetermined slope. The angle of the slopes are forward with respect to the direction of rotation of the stalk rolls. FIG. 18C simply illustrates that flute 180 has disengaged the corn stalk 320 and is rotating around for another cycle of engaging, pinching and pulling the corn plant stalk 320 down and through the row unit.

Having described the preferred embodiment, other features of the present invention will undoubtedly occur to those versed in the art, as will numerous modifications and alterations in the embodiments of the invention illustrated, all of which may be achieved without departing from the spirit and scope of the invention.

1. An improved separation element of a corn head row unit compromising:
a. a source of power for rotation,
b. at least two opposing stalk rolls connected to said power source,
c. said stalk rolls having at least one flute,
d. said flute having at least one penetration point; and,
wherein said penetration point is composed of hardened material.

2. An improved separation element of a corn head row unit compromising:
a. a source of power for rotation,
b. at least two opposing stalk rolls connected to said power source,
c. said stalk rolls having at least one flute,
d. said flute having a knife edge; and,
wherein said entire knife edge is composed of hardened material.

3. The separation element of said corn head row unit according to claim 2 wherein the knife edge has a predetermined surface slope.

4. The separation element of said corn head row unit according to claim 3 wherein the knife edges have a forward slope relative to the direction of rotation of each of said stalk rolls.

5. The separation element of said corn head row unit according to claim 4 wherein the knife edges of opposing flutes have a predetermined surface slope and the angle of said slopes of opposing flutes are identical.

6. The separation element of said corn head row unit according to claim 2 wherein the opposing flutes are tapered.

7. The separation element of said corn head row unit according to claim 2 wherein the opposing flutes intermesh.

8. The separation element of said corn head row unit according to claim 2 wherein the radius of the opposing flute surfaces is reduced in discrete increments along the length of the stalk roll.

9. The separation element of said corn head row unit according to claim 2 wherein the opposing flutes surfaces have a plurality of radii along the length of the stalk roll.

10. The separation element of said corn head row unit according to claim 2 wherein the radius of the leading edge of the flute is less than the trailing edge of the flute in relation to the direction of rotation of the stalk roll.

11. An improved separation element of a corn head row unit compromising:
a. a source of power for rotation,
b. at least two opposing stalk rolls connected to said power source,
c. each of said stalk rolls having at least one flute wherein the flutes are opposite each other,
d. said flutes having a knife edge; and,
e. said entire knife edge is composed of hardened material.

12. The separation element of said corn head row unit according to claim 11 wherein the distance between said opposing flutes decreases along the length of said stalk rolls.

13. The separation element of said corn head row unit according to claim 12 wherein the knife edges have a forward slope in relation to the direction of rotation of said stalk rolls.

14. The separation element of said corn head row unit according to claim 13 wherein the knife edge has a predetermined surface slope per stalk roll and said the angles of said slopes are identical.

15. The separation element of said corn head row unit according to claim 11 wherein the radius of the opposing flute surfaces is reduced in discrete increments along the length of the stalk roll.

16. The separation element of said corn head row unit according to claim 11 wherein the opposing flutes surfaces have a plurality of radii along the length of the stalk roll.

17. The separation element of said corn head row unit according to claim 11 wherein the radius of the leading edge of the flute is less than the trailing edge of the flute in relation to the direction of rotation of the stalk roll.

18. The separation element of said corn head row unit according to claim 11 wherein the opposing flutes are substantially in the shape of a trapezoid.

19. The separation element of said corn head row unit according to claim 11 wherein a substantially trapezoidal shaped void created is between the opposing flutes when opposite each.

20. An improved method of engaging corn plants with a corn head row unit compromising the steps of:
a. engaging the corn plant with a plurality of rotational elements,
b. pinching the corn plant between said rotational elements,
c. penetrating the corn plant stalk with said rotational elements a pre-determined penetration depth, wherein the pre-determined penetration depth of each of said rotational elements is less than half the diameter of the corn plant stalk,
d. pulling the corn plant stalk with the rotational elements,
e. said penetrating, pinching and pulling steps repeatedly lacerating the corn plant stalk along its length and width; and,
f. separating the corn plant ear from the corn plant stalk and husk.
